(19) United States
(12) Patent Application Publication
(10) Pub. No.: US 2008/0086898 A1
(43) Pub. Date: Apr. 17, 2008

(54) Assisting apparatus and actuating apparatus

(75) Inventor: Katsuhiko Hasegawa, Seki-shi (JP)

Correspondence Address: POSZ LAW GROUP, PLC, 12040 SOUTH LAKES DRIVE, SUITE 101, RESTON, VA, 20191, US

(73) Assignee: HASEGAWA HAMONO KABUSHIKI KAISHA, Seki-shi (JP)

(21) Appl. No.: 11/581,398

(22) Filed: Oct. 17, 2006

(51) Int. Cl. B26B 3/00

(52) U.S. Cl. 30/314

(57) ABSTRACT

An assisting apparatus assists an operating section. The operating section produces effect on a target surface. The assisting apparatus includes a retaining section for detachably retaining the operating section. An arranging section is placed on the target surface so as to arrange the retaining section on the target surface. An actuating section actuates the operating section such that the operating section produces effect on the target surface in a state where the retaining section retains the operating section. Therefore, an assisting apparatus that allow an operating section to easily and stably act on a target surface is provided.

### BACKGROUND OF THE INVENTION

The present invention relates to, for example, an assisting apparatus that assists an operating section provided with a blade in cutting paper, and to an actuating apparatus.

In the prior art, as an equipment that produces effect on a target surface, for example, a pen-type cutter has been proposed that is disclosed in Japanese Laid-Open Patent Publication No. 10-71281.

As shown in FIG. 9, a cutter 51 is provided with a cutter holder 53 located at the distal end of a shank 52 of the cutter 51. A pipe 56 is press fitted in the cutter holder 53. The pipe 56 supports a blade holder 55 having a cutting blade 54 to be rotatable in the circumferential direction of the shank 52. When using the cutter 51, a user grasps the outer circumferential surface of the shank 52 in the same manner as when the user grasps a pen. The user causes the side of a hand to abut against a paper surface so that the shank 52 is stable, and then causes the cutting blade 54 of the cutter 51 to be engaged in the paper surface. In the state where the cutting blade 54 is engaged in the paper surface, the user slides the side of the hand along the paper surface so that the shank 52 moves, thereby cutting the sheet of paper.

As described above, when using the cutter 51, the user must grasp the shank 52. For example, the user holds the shank 52 with a thumb and an index finger while supporting the shank 52 with a middle finger.

However, sick people who have not enough grasping power or people with finger disability cannot hold the shank 52 satisfactorily, and it is almost impossible for them to fully use the cutter 51 while grasping the shank 52. Furthermore, even if such people managed to grasp the outer circumferential surface of the cutter 51, it is difficult to stabilize the posture of the cutter 51 when cutting paper. This is because it is difficult for such people to slide the shank 52 along the paper surface while abutting the side of the hand against the paper surface.

### SUMMARY OF THE INVENTION

Accordingly, it is an objective of the present invention to provide an assisting apparatus and an actuating apparatus that allow an operating section to easily and stably act on a target surface.

According to one aspect of the invention, an assisting apparatus for assisting an operating section is provided. The operating section produces effect on a target surface. The assisting apparatus includes a retaining section for detachably retaining the operating section. An arranging section is placed on the target surface so as to arrange the retaining section on the target surface. An actuating section actuates the operating section such that the operating section produces effect on the target surface in a state where the retaining section retains the operating section.

According to another aspect of the invention, an assisting apparatus for actuating a detecting section is provided. The detecting section detects a target surface. The assisting apparatus includes: a retaining section for detachably retaining the detecting section; an arranging section placed on the target surface so as to arrange the retaining section on the target surface; and an actuating section for actuating the detecting section such that the detecting section detects the target surface in a state where the retaining section retains the detecting section.

According to another aspect of the invention, an actuating apparatus including an operating section for producing effect on a target surface is provided. The actuating apparatus includes a retaining section for retaining the operating section; an arranging section placed on the target surface so as to arrange the operating section on the target surface by means of the retaining section; and an actuating section for actuating the operating section to produce effect on the target surface.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a side view illustrating a cutting apparatus according to one embodiment of the present invention;

FIG. 1B is a plan view illustrating the cutting apparatus of FIG. 1A;

FIG. 2A is a front view illustrating the cover shown in FIG. 1A;

FIG. 2B is a bottom view illustrating the inner surface of the cover of FIG. 2A;

FIG. 2C is a plan view illustrating the bottom plate shown in FIG. 1A;

FIG. 2D is a side view illustrating the bottom plate of FIG. 2C;

FIG. 3A is a side view illustrating the retaining mechanism shown in FIG. 1A;

FIG. 3B is a plan view illustrating the retaining mechanism of FIG. 3A;

FIG. 4 is an explanatory diagram of an assembling procedure of the cutting mechanism shown in FIG. 1A;

FIG. 5 is an explanatory diagram explaining an assembling procedure of the cutting apparatus of FIG. 1A;

FIG. 6A is a partial side view illustrating an unlocked state of a lock mechanism of a cutting apparatus according to a modified embodiment;

FIG. 6B is a partial side view illustrating a locked state of the lock mechanism of FIG. 6A;

FIG. 7 is a partial side view illustrating a blade edge and a blade edge holder according to another modified embodiment;

FIG. 8A is a side view illustrating a blade edge holder according to another modified embodiment;

FIG. 8B is a bottom view of FIG. 8A; and

FIG. 9 is a cross-sectional view illustrating a prior art cutter.

### DETAILED DESCRIPTION OF THE PREFERRED EMBODIMENTS

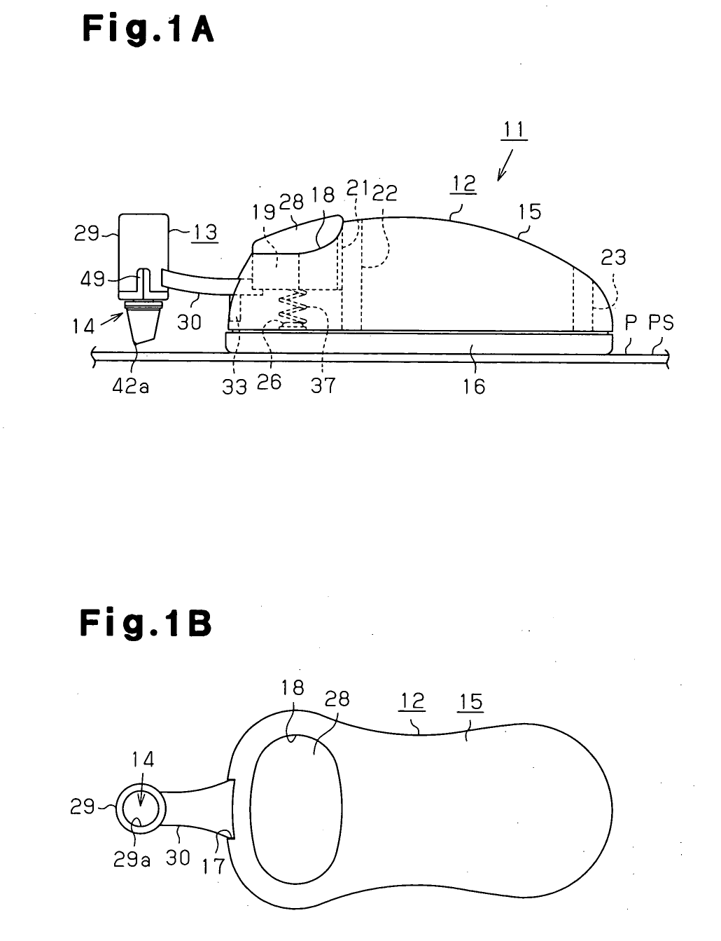

One embodiment of the present invention will now be described with reference to FIGS. 1A to 5.

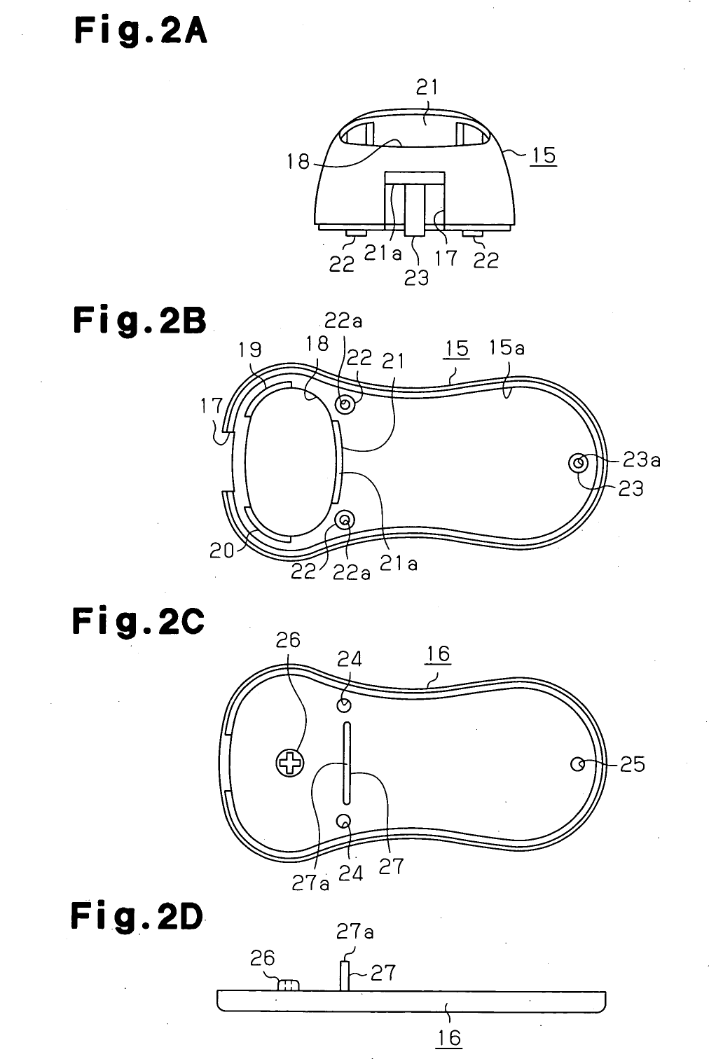

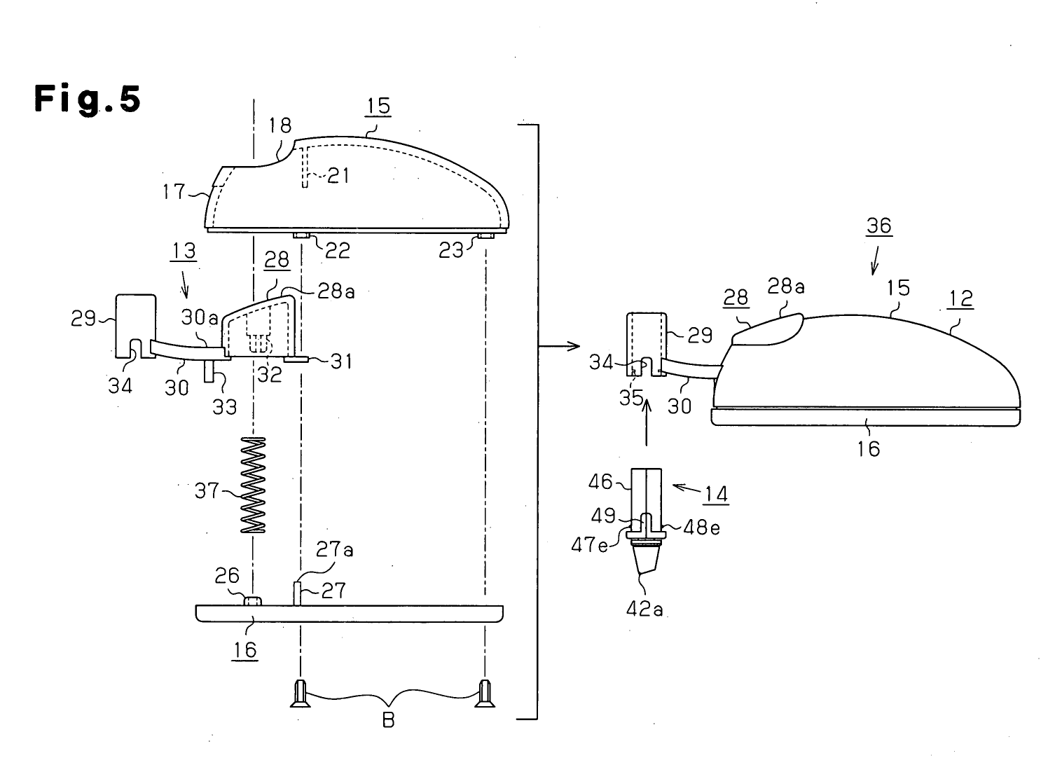

As shown in FIGS. 1A and 1B, a cutting apparatus 11, which is an actuating apparatus in this embodiment, includes an arranging mechanism 12, a cutting mechanism 14, which is an operating section for cutting a sheet of paper P in this embodiment, and a retaining mechanism 13, which is a retaining section for detachably retaining the cutting mechanism 14 in this embodiment. The arranging mechanism 12 located on a paper surface PS, which is a target surface in this embodiment, arranges the retaining mechanism 13. As shown in FIGS. 2A to 2D and 5, the arranging mechanism 12 has an ergonomic shape based on ergonomics. The arranging mechanism 12 includes a resin transparent cover 15 and a resin bottom plate 16, which closes an opening 15a of the cover 15. In the preferred embodiment, the cover 15 and the bottom plate 16 are made of acrylonitrile-butadiene-styrene resin (ABS resin). However, the material of the cover 15 and the bottom plate 16 is not limited to this, but may be changed as required. In the drawing, the portion toward the retaining mechanism 13 of the arranging mechanism 12, that is, the left side of FIG. 1A is the front side of the cutting apparatus 11, and the portion opposite to the retaining mechanism 13, that is, the right side of FIG. 1A is the rear side of the cutting apparatus 11.

As shown in FIGS. 1B, 2A, and 2B, a rectangular recess 17 is formed in the front surface of the cover 15, which extends in the front and rear direction. An elliptical through hole 18, which extends in the lateral direction (vertical direction in FIG. 2B), is formed at the top of the front side of the cover 15. As shown in FIG. 2B, three plate-like guide sections 19 to 21 are formed on the inner surface of the cover 15 at approximately equal intervals at three locations along the circumference of the through hole 18. The guide sections 19, 20 are formed at both ends of the front side of the through hole 18, and the gap between the guide sections 19, 20 is set greater than the recess 17. The guide section 21 is formed at the rear of the through hole 18. Two columns 22 are formed on the inner surface of the cover 15 on both sides of the guide section 21. Furthermore, a column 23 is formed at the rear end of the cover 15. The columns 22, 23 are respectively provided with holes 22a, 23a.

As shown in FIGS. 2C and 2D, the planar shape of the bottom plate 16 is identical to the opening 15a of the cover 15. The lower surface of the bottom plate 16 is machined to suppress friction resistance. Through holes 24, 25 are formed in the bottom plate 16 corresponding to the holes 22a, 23a.

As shown in FIGS. 2A to 2D and 5, when assembling the bottom plate 16 to the cover 15, first, the opening 15a of the cover 15 is closed with the bottom plate 16. In a state where the holes 22a, 23a of the cover 15 are aligned with the through holes 24, 25 of the bottom plate 16, screws B are inserted in the through holes 24, 25 and the holes 22a, 23a from beneath the bottom plate 16 as shown in FIG. 5.

A columnar spring bearing 26 is formed on the upper surface of the bottom plate 16 corresponding to the center of the through hole 18 of the cover 15. Furthermore, a plate-like stopping section 27, which extends in the lateral direction (vertical direction in FIG. 2C) of the bottom plate 16, is formed on the upper surface of the bottom plate 16 between the through holes 24. In a state where the bottom plate 16 is assembled to the cover 15, the stopping section 27 is located rearward of the guide section 21. An upper surface 27a of the stopping section 27 is located lower than a lower surface 21a of the guide section 21.

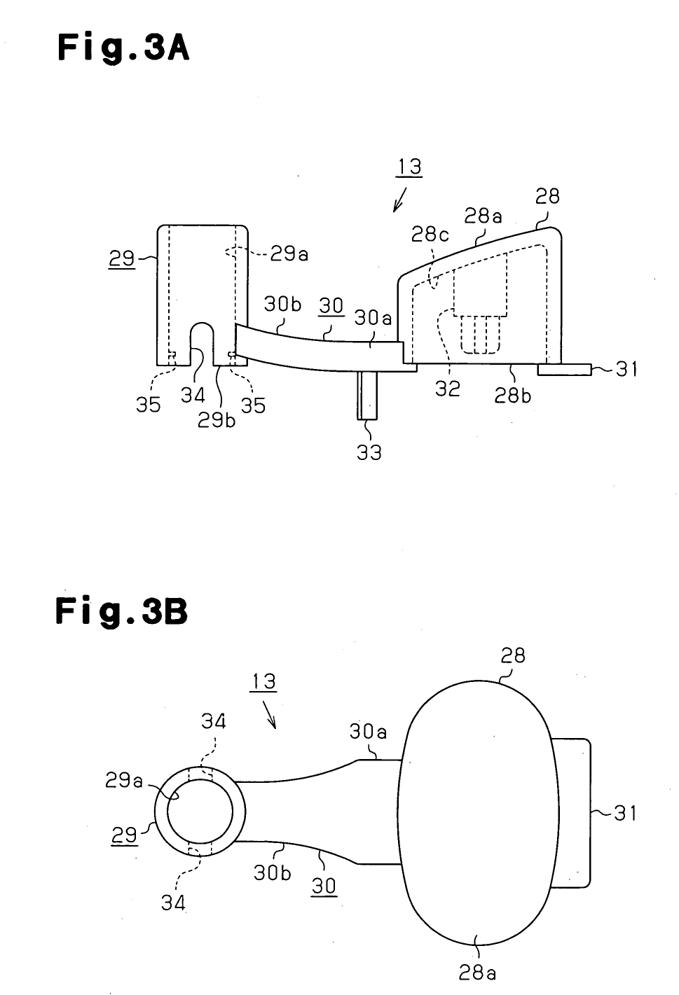

As shown in FIGS. 3A and 3B, the retaining mechanism 13 made of resin includes, an actuating section 28, a retaining section 29, and a connector 30, which connects the actuating section 28 to the retaining section 29. The actuating section 28 is located rearward of the retaining section 29. The retaining section 29 detachably retains the cutting mechanism 14. In the preferred embodiment, the retaining mechanism 13 is made of ABS resin. However, the material is not limited to this, but may be changed as required.

The actuating section 28 is elliptical, and can be inserted in the through hole 18 of the cover 15. As shown in FIG. 3A, an upper surface 28a of the actuating section 28 is inclined such that the front part of the upper surface 28a lowers. An opening 28b is formed at the lower end of the actuating section 28, and a rectangular flange piece 31 is formed at the rear of the opening 28b. A columnar spring bearing 32 is formed on a ceiling surface 28c provided inside the actuating section 28.

The connector 30 extends forward from the lower portion of the actuating section 28 so as to curve upward. As shown in FIG. 3B, the connector 30 includes a wide section 30a located closer to the actuating section 28 and a narrow section 30b located closer to the retaining section 29. The width of the narrow section 30b, that is, the dimension in the left and right direction is reduced towards the retaining section 29. The width of the wide section 30a is set smaller than that of the recess 17 of the cover 15. A plate-like stopper 33, which extends downward, is formed on the wide section 30a at the boundary between the wide section 30a and the narrow section 30b.

The cutting mechanism 14 is inserted in a through hole 29a of the cylindrical retaining section 29 shown in FIG. 3A. The retaining section 29 retains the cutting mechanism 14 inserted in the through hole 29a. The retaining section 29 has an opening 29b at the bottom. A pair of slits 34 are formed at the lower part of the retaining section 29 so as to extend from the opening 29b. When inserting the cutting mechanism 14 in the retaining section 29, the retaining section 29 flexes in the vicinity of the slits 34 so that the diameter of the through hole 29a slightly increases. A pair of grooves 35 extending in the circumferential direction are formed in the inner circumferential surface of the retaining section 29. In the preferred embodiment, the arranging mechanism 12 and the retaining mechanism 13 configure an assisting apparatus 36. The assisting apparatus 36 assists the cutting mechanism 14 in cutting the sheet of paper P.

As shown in FIG. 5, when assembling the assisting apparatus 36, the actuating section 28 of the retaining mechanism 13 is inserted in the through hole 18 of the cover 15. Then, in a state where the connector 30 is arranged in the recess 17, the bottom plate 16 is attached to the cover 15 with the screws B. The stopper 33 of the retaining mechanism 13 is arranged in the arranging mechanism 12. A coil spring 37 is arranged between the spring bearing 32 of the actuating section 28 and the spring bearing 26 of the bottom plate 16. The coil spring 37 urges the retaining mechanism 13 upward. Therefore, the upper surface of the flange piece 31 of the actuating section 28 abuts against the guide section 21 of the cover 15. Furthermore, the upper surface of the wide section 30a abuts against the upper surface of the recess 17. As described above, in the state where the flange piece 31 abuts against the guide section 21 and the wide section 30a abuts against the upper surface of the recess 17, the axis of the cylindrical retaining section 29 is perpendicular to the lower surface of the bottom plate 16. That is, the arranging mechanism 12 arranges the retaining section 29 such that the axis of the retaining section 29 is perpendicular to the lower surface of the bottom plate 16. The arranging mechanism 12 includes the coil spring 37, the cover 15, and the bottom plate 16. The upper surface 28a of the actuating section 28 protrudes from the through hole 18 of the cover 15.

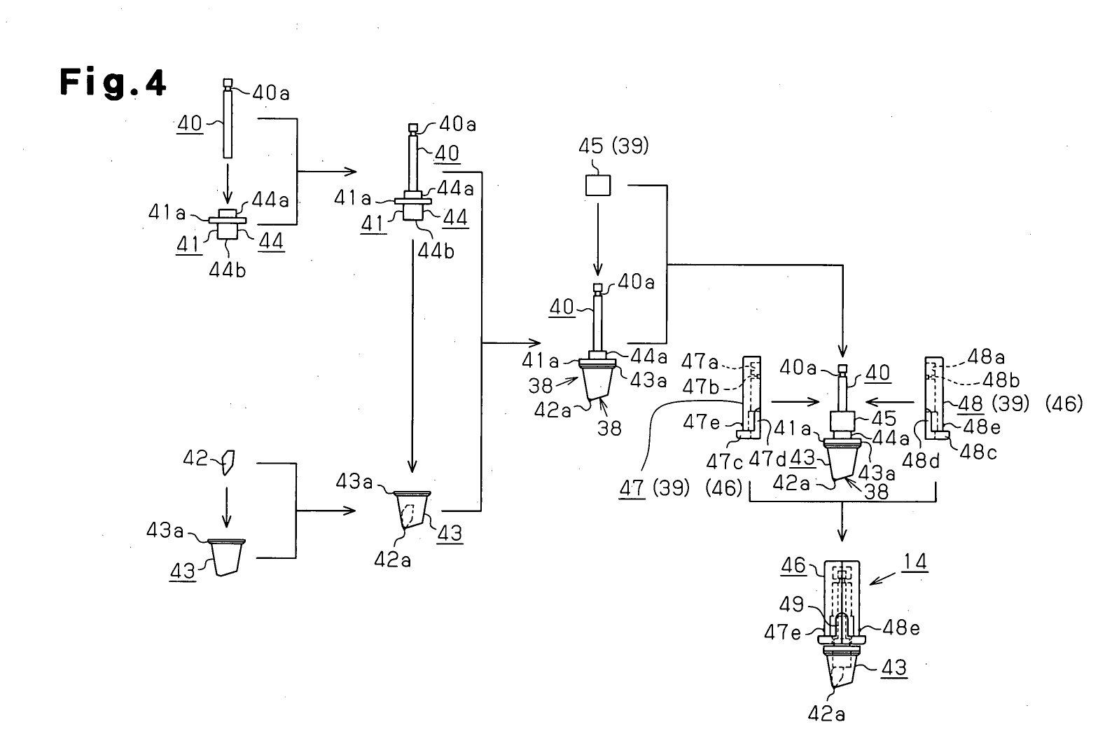

As shown in FIG. 4, the cutting mechanism 14 includes a rotor 38 and a bearing mechanism 39, which rotatably supports the rotor 38. The rotor 38 includes a rotary shaft 40 made of stainless-steel, a resin lid 41, and a resin head 43. A blade 42 is attached to the head 43. The materials of the rotary shaft 40, the lid 41, and the head 43 are not limited to the above mentioned materials, but may be changed as required.

The round bar-like rotary shaft 40 has a small diameter portion 40a in the vicinity of the upper end. The lid 41 includes a column 44 and a flange 41a, which is formed on the outer circumferential surface of the column 44. The column 44 includes a first column portion 44a located upper than the flange 41a and a second column portion 44b located lower than the flange 41a. A socket (not shown) for the rotary shaft 40 is formed on the upper surface of the first column portion 44a. A fitting bore (not shown) for the blade 42 is formed on the lower surface of the second column portion 44b. The head 43 is cup-shaped, and accommodates the blade 42. A flange 43a is formed at the upper portion of the head 43, that is, at the opening. The opening of the head 43 is formed so as to allow the second column portion 44b to be fitted. The bottom surface 43b of the head 43 is inclined. A through hole (not shown) is formed at the lowermost end of the head 43 to allow a blade tip 42a, which is the distal end of the blade 42, to be exposed outside the head 43. The blade tip 42a functions as a contact portion with respect to the paper surface PS.

When assembling the rotor 38, first, the blade 42 is arranged in the head 43 such that the blade tip 42a protrudes from the head 43. The rotary shaft 40 is secured to the first column portion 44a of the column 44. The second column portion 44b is then fitted in the opening of the head 43.

The bearing mechanism 39 of the cutting mechanism 14 includes a resin bush 45 and a resin bearing 46. The material of the bush 45 and the bearing 46 is not limited to the above mentioned material, but may be changed as required. The bush 45 is cylindrical, and the inner diameter of the bush 45 is slightly greater than the outer diameter of the rotary shaft 40. That is, the inner diameter of the bush 45 is set so as to permit the rotation of the rotary shaft 40 while the bush 45 suppresses the inclination of the rotary shaft 40, which is inserted in the bush 45. The bush 45 abuts against the first column portion 44a. The bearing 46 is shaped as an inverted cup and includes a first bearing 47 and a second bearing 48. The first bearing 47 and the second bearing 48 cover the first column portion 44a, the bush 45, and the rotary shaft 40. The outer diameter of the bearing 46 is set such that the bearing 46 accommodated in the retaining section 29 is prevented from falling off the retaining section 29.

The first bearing 47 and the second bearing 48 are identical in shape. The first bearing 47 and the second bearing 48 define a space for accommodating the first column portion 44a, the bush 45, and the rotary shaft 40. The lower section of the accommodating space is connected to the outside. Projections 47b, 48b are respectively formed on inner surfaces 47a, 48a of the first bearing 47 and the second bearing 48 along the circumferential direction at a position corresponding to the small diameter portion 40a. The projections 47b, 48b rotatably hold the small diameter portion 40a of the rotary shaft 40. Furthermore, parts of the inner surfaces 47a, 48a that accommodate the bush 45 are recessed, and sandwich the bush 45 from the top and the bottom so that the bush 45 does not rotate. The inner circumferential surfaces of the projections 47b, 48b, and the bush 45 rotatably support the rotary shaft 40 accommodated in the bearing 46.

Flanges 47c, 48c are respectively formed at the lower ends of the first bearing 47 and the second bearing 48. The dimension between the upper surface of the flanges 47c, 48c and the upper surface of the bearing 46 is set equal to the dimension of the longitudinal direction of the retaining section 29. A pair of projections 47d are formed on the first bearing 47 and a pair of projections 48d are formed on the second bearing 48. The projections 47d extend from both ends of the outer circumferential surface of the first bearing 47 upward of the flange 47c. The projections 48d extend from both ends of the outer circumferential surface of the second bearing 48 upward of the flange 48c. The projections 47d and the projections 48d configure an insertion section 49, which is inserted in the slits 34 of the retaining section 29. Furthermore, projections 47e, 48e, which fit in the grooves 35 of the retaining section 29, are formed on the outer circumferential surfaces of the first bearing 47 and the second bearing 48.

When assembling the cutting mechanism 14, the first bearing 47 and the second bearing 48 cover the first column portion 44a, the bush 45, and the rotary shaft 40. When the first bearing 47 is secured to the second bearing 48, the bearing mechanism 39 rotatably supports the rotor 38. The distance between the rotation axis of the rotary shaft 40 and the blade tip 42a is preferably set greater than or equal to the radius of the rotary shaft 40. In the preferred embodiment, the distance is set slightly greater than the radius of the rotary shaft 40. Therefore, when the rotary shaft 40 rotates, the blade tip 42a rotates outside of the rotary shaft 40.

Next, attaching and detaching procedures of the cutting mechanism 14 to and from the retaining section 29 will be described with reference to FIGS. 1A and 5.

As shown in FIG. 5, the bearing 46 of the cutting mechanism 14 is inserted in the retaining section 29. Then, the projections 47e, 48e on the outer circumferential surface of the bearing 46 engage with grooves 35 provided in the inner circumferential surface of the retaining section 29. Furthermore, the insertion section 49 of the cutting mechanism 14 engages with the slits 34 of the retaining section 29. As a result, the retaining section 29 retains the cutting mechanism 14 as shown in FIG. 1A. In the state where the retaining section 29 retains the cutting mechanism 14, the upper surface of the cutting mechanism 14 is flush with the upper surface of the retaining section 29. In the state shown in FIG. 1A, the rotor 38 and the blade 42 of the cutting mechanism 14 are rotatable relative to the retaining section 29.

In the state shown in FIG. 1A, the blade tip 42a of the cutting mechanism 14 is located upper than the lower surface of the bottom plate 16. For example, when the user depresses the actuating section 28 causing the flange piece 31 to abut against the upper surface 27a of the stopping section 27, the blade tip 42a is located slightly lower than the lower surface of the bottom plate 16. The distance between the flange piece 31 of the actuating section 28 and the stopping section 27 of the bottom plate 16 in the state shown in FIG. 1A is set to achieve the above described state. The flange piece 31 and the stopping section 27 function as a stopping section for preventing the retaining section 29 and the cutting mechanism 14 from moving further downward when the blade tip 42a is located slightly lower than the bottom plate 16.

Furthermore, the distance between the stopper 33 of the actuating section 28 and the bottom plate 16 is also set such that the blade tip 42a is located slightly lower than the lower surface of the bottom plate 16 when the stopper 33 abuts against the bottom plate 16. The stopper 33 and the bottom plate 16 also function as a stopping section for preventing the retaining section 29 (cutting mechanism 14) from moving further downward in the state where the blade tip 42a is located slightly lower than the lower surface of the bottom plate 16. That is, the stopping sections are located in front and rear of the actuating section 28.

For example, in the state shown in FIG. 1A, when detaching the cutting mechanism 14 from the retaining section 29, the upper surface of the cutting mechanism 14 is depressed downward with respect to the retaining section 29. This disengages the projections 47e, 48e of the cutting mechanism 14 from the grooves 35 of the retaining section 29. Furthermore, the insertion section 49 of the cutting mechanism 14 is also disengaged from the slits 34 of the retaining section 29.

Next, cutting of the sheet of paper P with the cutting apparatus 11 will be described with reference to FIG. 1A.

First, the user places the cutting apparatus 11 on the paper surface PS. In this state, the arranging mechanism 12 arranges the retaining section 29 and the cutting mechanism 14 above the paper surface PS. That is, the arranging mechanism 12 arranges the blade tip 42a of the cutting mechanism 14 apart from the paper surface PS. Then, when the user places a hand on the arranging mechanism 12 and depresses the actuating section 28, the actuating section 28 moves downward while being guided along the guide sections 19 to 21 of the cover 15. As a result, the retaining section 29 approaches the paper surface PS, and the blade tip 42a is eventually engaged in the sheet of paper P. In the state where the blade tip 42a is engaged in the sheet of paper P, the flange piece 31 of the retaining section 29 abuts against the stopping section 27 of the bottom plate 16, and the stopper 33 abuts against the upper surface of the bottom plate 16. In the state where the blade tip 42a is engaged in the sheet of paper P, the arranging mechanism 12 and the retaining section 29 support the rotary shaft 40 to be perpendicular to the paper surface PS. The blade tip 42a of the cutting mechanism 14 functions as a contact portion of the operating section (14) with respect to the target surface (PS).

When the user moves the hand placed on the arranging mechanism 12 along the paper surface PS while maintaining the blade tip 42a to be engaged in the sheet of paper P by maintaining force of depressing the actuating section 28, the arranging mechanism 12 slides along the paper surface PS, and the blade 42 cuts the sheet of paper P. When the user, for example, moves the hand in a manner as to draw a curved line, the arranging mechanism 12 also slides along the paper surface PS in a manner as to draw a curved line. Following such movement of the arranging mechanism 12, the blade 42 cuts the sheet of paper P in a manner as to draw a curved line.

In order to cut the sheet of paper P in accordance with the free movement of the arranging mechanism 12, the direction of the blade 42 needs to be changed from moment to moment. In the preferred embodiment, the rotary shaft 40, which supports the blade 42, is supported to be rotatable with respect to the actuating section 28. Therefore, the blade 42 smoothly rotates to be suitably oriented for cutting the sheet of paper P corresponding to the free movement of the arranging mechanism 12. Therefore, the sheet of paper P is easily cut into any shape while reducing resistance of changing the direction of the blade 42.

The preferred embodiment has the following advantages.

(1) The assisting apparatus 36 includes the retaining mechanism 13 and the arranging mechanism 12. The retaining mechanism 13 includes the retaining section 29 and the actuating section 28. Therefore, when the arranging mechanism 12 is placed on the paper surface PS, the cutting mechanism 14 is arranged above the paper surface PS. When the actuating section 28 is depressed, the blade tip 42a is engaged in the sheet of paper P. Therefore, for example, the user can easily and stably make the blade tip 42a to be engaged in the sheet of paper P by moving the hand placed on the arranging mechanism 12 along the paper surface PS. Furthermore, since the user can easily retain the cutting mechanism 14 and even stabilize the posture of the cutting mechanism 14 with a simple operation of placing the hand on the arranging mechanism 12, the preferred embodiment provides fine operability to sick people who have not enough grasping power or people with finger disability.

(2) The cutting apparatus 11 includes the retaining mechanism 13, the arranging mechanism 12 and the cutting mechanism 14. Thus, the cutting apparatus 11 also has the advantage (1).

(3) When the actuating section 28 is not depressed, the arranging mechanism 12 arranges the retaining section 29 such that the blade tip 42a of the cutting mechanism 14 is located apart from the paper surface PS. Therefore, while the user moves the arranging mechanism 12 to a desired position, the blade tip 42a is prevented from damaging or cutting the sheet of paper P.

(4) In the state where the blade tip 42a is engaged in the sheet of paper P, the retaining mechanism 13 maintains the rotation axis of the rotary shaft 40 and the blade 42 to be perpendicular to the paper surface PS. When moving the arranging mechanism 12 along the paper surface PS in a manner, for example, as to draw a curved line, the blade 42 smoothly rotates in accordance with the movement of the arranging mechanism 12 and cuts the sheet of paper P along the curved line.

For example, when using the cutter 51 described in BACKGROUND OF THE INVENTION, the user uses the cutter 51 in a state where the cutter 51 is inclined with respect to an imaginary line that is perpendicular to the paper surface in the same manner as when writing with a pen. In this case, the blade holder 55 inclines with respect to the paper surface. In this case, when rotating the cutter 51 with the cutting blade 54 engaged in the paper surface, the sliding resistance between the blade holder 55 and the inner circumferential surface of the pipe 56, which rotatably supports the blade holder 55, is increased. This hinders the cutting blade 54 from smoothly rotating. The preferred embodiment eliminates such disadvantages.

(5) The assisting apparatus 36 and the cutting apparatus 11 includes a set of the flange piece 31 and the stopping section 27, and a set of the stopper 33 and the bottom plate 16. Therefore, in the state where the blade tip 42a is engaged in the sheet of paper P, the cutting mechanism 14 is easily and reliably prevented from moving further downward. Therefore, the blade 42 is suppressed from being excessively engaged in the sheet of paper P, and the amount of the blade 42 engaged in the sheet of paper P is always kept the same without varying between individuals. For example, by adjusting the amount of the blade tip 42a to be engaged in the sheet of paper P, an advanced cutting specification is easily performed as to cut only the uppermost sheet of paper P among several papers P piled on one another every time without variation between individuals. To adjust the amount of the blade tip 42a to be engaged in the sheet of paper P, the distance between the flange piece 31 and the stopping section 27 is adjusted, and furthermore, the distance between the stopper 33 and the bottom plate 16 is adjusted.

(6) In the state where the blade tip 42a is engaged in the sheet of paper P, the retaining section 29 and the cutting mechanism 14 are located in front of the arranging mechanism 12. Therefore, it is easy to grasp the amount of the blade tip 42a engaged in the sheet of paper P.

(7) The retaining section 29, which retains the cutting mechanism 14, is apart from the cover 15 on which the user places the hand. This contributes in enhancing safety.

(8) Depressing the actuating section 28 of the assisting apparatus 36 and the cutting apparatus 11 causes the blade tip 42a to be engaged in the sheet of paper P. Therefore, the state where the blade tip 42a is engaged in the sheet of paper P is achieved with a simple operation.

(9) The arranging mechanism 12 easily slides along the paper surface PS by moving the hand placed on the arranging mechanism 12. Therefore, the cutting mechanism 14 is moved along the paper surface PS with a simple operation.

(10) The lower surface of the bottom plate 16 is machined to suppress friction resistance. Therefore, the assisting apparatus 36 and the cutting apparatus 11 are moved along the paper surface PS even more smoothly.

(11) The assisting apparatus 36 and the cutting apparatus 11 includes the retaining section 29, which is detachable from the arranging mechanism 12. Therefore, even if the cutting mechanism 14 gets broken, it is not necessary to exchange the assisting apparatus 36 or the entire cutting apparatus 11, but only the cutting mechanism 14 may be exchanged. Furthermore, when the cutting apparatus 11 is not in use, the cutting mechanism 14 may be detached from the assisting apparatus 36 and the cutting apparatus 11, which enhances safety when not in use.

(12) The cutting mechanism 14 is inserted in the retaining section 29 so that the cutting mechanism 14 is attached to the retaining section 29. Therefore, the cutting mechanism 14 can be attached to the retaining section 29 with a simple operation.

(13) In the state where the cutting mechanism 14 is attached to the retaining section 29, when the upper surface of the cutting mechanism 14 is depressed downward with respect to the retaining section 29, the cutting mechanism 14 is detached from the retaining section 29. Therefore, the cutting mechanism 14 is detached from the retaining section 29 with a simple operation. Furthermore, the upper surface of the cutting mechanism 14, which upper surface is depressed, is located opposite to the lower part of the cutting mechanism 14 at which the blade 42 is arranged. This contributes in enhancing the safety in detaching the cutting mechanism 14 from the retaining section 29.

The preferred embodiment may be modified as follows.

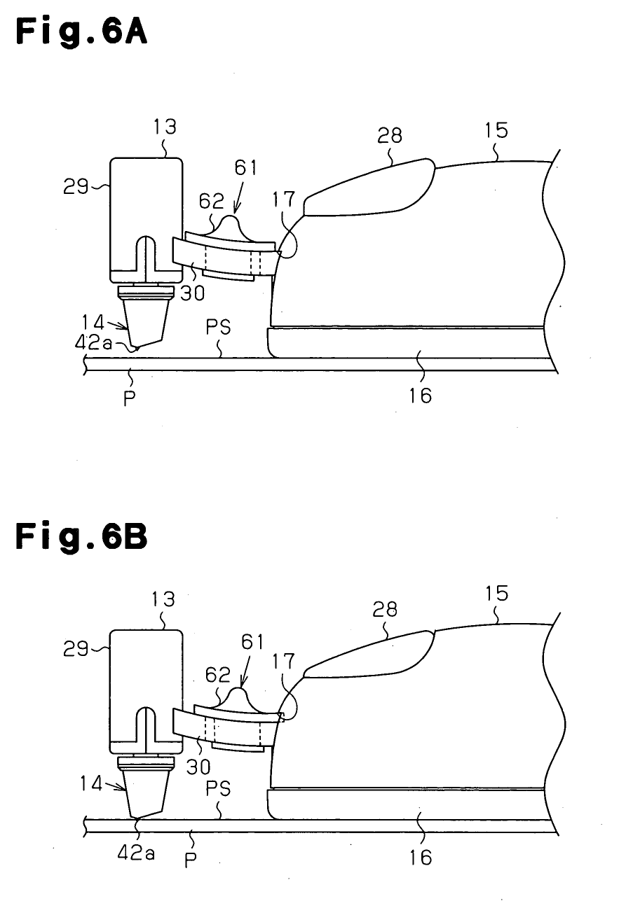

As shown in FIGS. 6A and 6B, a lock mechanism 61 may be added. The lock mechanism 61 locks the actuating section 28 to the arranging mechanism 12 in the state where the actuating section 28 is depressed such that the blade tip 42a abuts against the paper surface PS. That is, the lock mechanism 61 restricts force of the coil spring 37 from restoring the actuating section 28 from a lower position to an upper position.

The lock mechanism 61 is slidable. That is, the lock mechanism 61 includes a lock lever 62, which slides back and forth relative to the connector 30. As shown in FIG. 6A, in a state where the actuating section 28, which is a push-button, is not depressed and is at the upper position, the lock lever 62 is at a front position, or an unlock position.

As shown in FIG. 6B, in a state where the actuating section 28 is depressed to the lower position causing the blade tip 42a to abut against the paper surface PS, the lock lever 62 is slid from the front position to a rear position, which is a lock position. Accordingly, the rear end of the lock lever 62 is inserted in the opening 15a of the cover 15. Therefore, the lock lever 62 is sandwiched between the upper edge of the opening 15a and the connector 30. As a result, the actuating section 28 and the cutting mechanism 14 are restricted from moving upward by the amount corresponding to the thickness of the lock lever 62 and stay at the lower position. That is, the actuating section 28 and the cutting mechanism 14 are locked at the lower position. Therefore, even if the user removes the hand from the actuating section 28, the cutting mechanism 14 stays at the lower position permitting the user to cut the sheet of paper P.

The lock mechanism 61 is unlocked by sliding the lock lever 62 from the lock position to the unlock position. As a result, the lock lever 62 is no longer sandwiched between the upper edge of the opening 15a and the connector 30, and the actuating section 28 and the cutting mechanism 14 move upward by the force of the coil spring 37.

In the embodiment illustrated in FIGS. 1A to 5, the actuating section 28, which is a push-button, needs to be kept pressed to cut the sheet of paper P. When the hand is removed from the actuating section 28, the cutting mechanism 14 is lifted by the force of the coil spring 37, thereby undesirably separating the blade tip 42a from the paper surface PS. To keep pressing the actuating section 28 downward, which is perpendicular to the paper surface PS, while moving the arranging mechanism 12 on a two-dimensional plane parallel to the paper surface PS is still a complicated operation and is thus tiring.

According to the lock mechanism 61 shown in FIGS. 6A and 6B, the user depresses the actuating section 28 for cutting operation only at the beginning when moving the actuating section 28 from the upper position to the lower position. Subsequently, by manipulating the lock mechanism 61 to lock the cutting mechanism 14 at the lower position, the user does not need to depress the actuating section 28 against the force of the coil spring 37. Therefore, burden on the hand and tiredness caused by depressing the actuating section 28 are significantly reduced. The user can concentrate on manipulating the arranging mechanism 12 on the two-dimensional plane parallel to the paper surface PS without being distracted by the operation of depressing the actuating section 28. Therefore, the user can perform finer cutting operation. As the cutting operation becomes longer, the effect becomes significant.

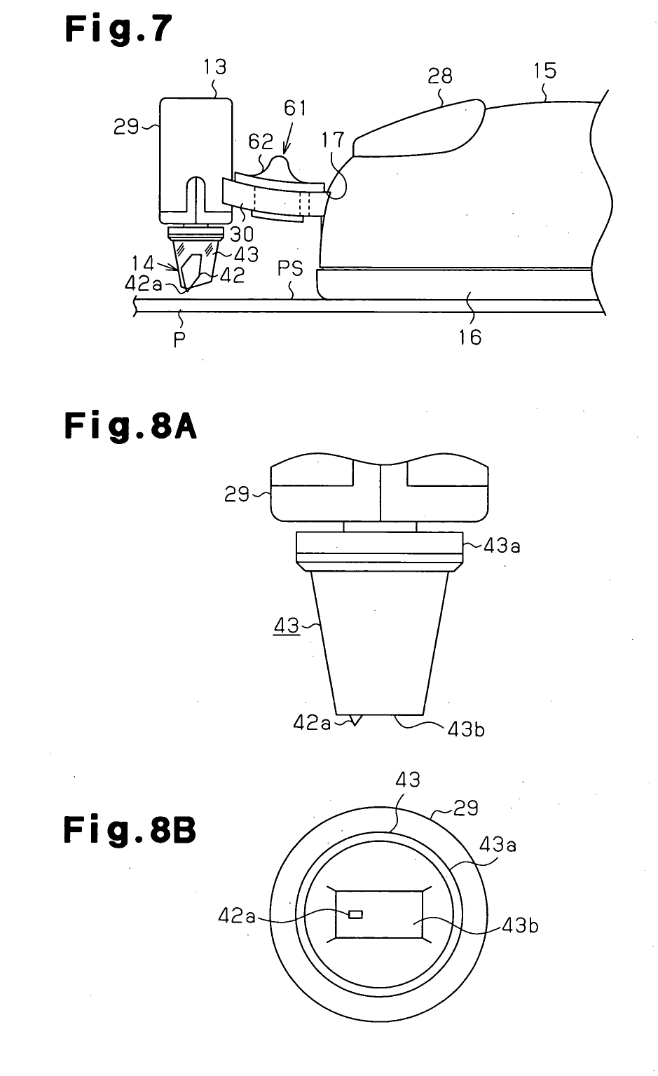

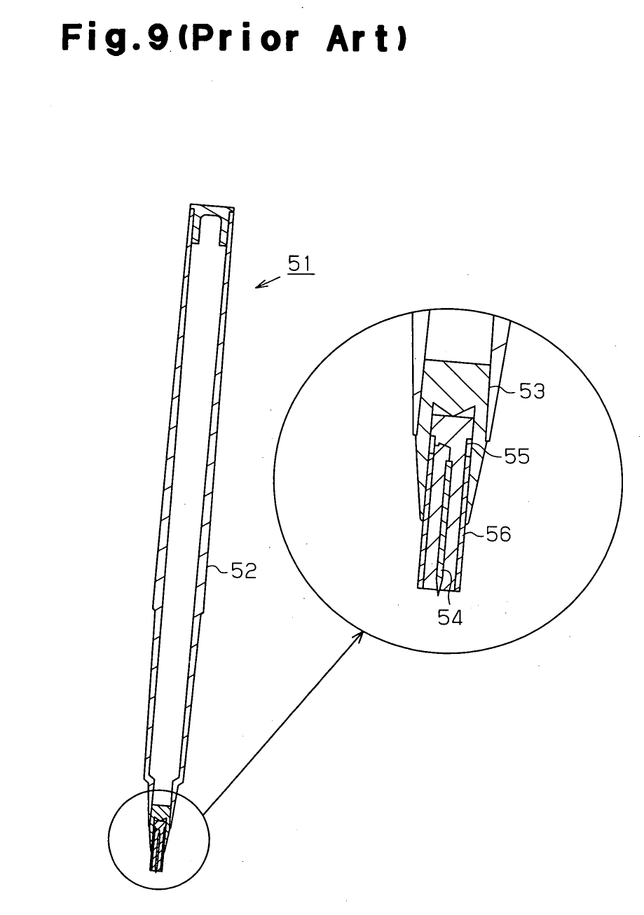

As shown in FIG. 7, the head 43, which is a blade edge holder, may be transparent so that the blade 42 can be seen from the outside. In this case, since the visibility of the blade 42 is improved, the user can check the position and the orientation of the blade 42 at any time while cutting the sheet of paper P. Therefore, the sheet of paper P is finely and reliably cut into a desired shape easily. The user can check the position and the orientation of the blade 42 without lifting the arranging mechanism 12 from the paper surface PS. Therefore, the position and the orientation of the blade 42 can be checked while continuing the cutting operation, that is, without stopping cutting of the sheet of paper P. This improves the operation efficiency.

As shown in FIGS. 8A and 8B, a bottom surface 43b of the head 43 may be a plane parallel to the paper surface PS. In the preferred embodiment illustrated in FIGS. 1A to 5, the bottom surface 43b of the head 43 is inclined. In comparison to the preferred embodiment, according to the modified embodiment illustrated in FIGS. 8A and 8B, the flat bottom surface 43b of the head 43 can be enlarged. In the state where the actuating section 28 is depressed such that the blade tip 42a cuts the sheet of paper P, the bottom surface 43b presses the paper surface PS. The bottom surface 43b surrounds the blade tip 42a. That is, the blade tip 42a cuts the sheet of paper P with the bottom surface 43b pressing the sheet of paper P around the blade tip 42a. This suppresses the sheet of paper P from curling up while the blade tip 42a cuts the sheet of paper P. Therefore, the cutting operation is reliably performed.

While moving the arranging mechanism 12 on the paper surface PS to cut the sheet of paper P, the bottom surface 43b moves and rotates in accordance with the movement and the rotation of the blade tip 42a. Therefore, the bottom surface 43b always suppresses the sheet of paper P from curling up while the blade tip 42a cuts the sheet of paper P and enables the user to reliably cut the sheet of paper P. For example, the user can smoothly cut the sheet of paper P along a fine curved line with a small radius of curvature.

The shape of the bottom surface 43b need not be rectangular, but may be circular or other shapes.

In the preferred embodiment, the flange piece 31 and the stopping section 27 may be omitted. Furthermore, only the stopper 33 may be omitted, or the flange piece 31, the stopping section 27, and the stopper 33 may all be omitted.

The stopping section may be modified as required as long as the stopping section prevents the retaining section 29 (the cutting mechanism 14) from moving further downward in the state where the blade tip 42a is engaged in the sheet of paper P.

The stopping section 27 according to the preferred embodiment may be omitted, and the lower surface of the actuating section 28 may be at the same level as the lower surface of the stopper 33.

In the preferred embodiment, the target surface is not limited to the paper surface PS, but may be modified as required. For example, a surface of a resin seat or a wooden thin plate may be the target surface.

In the preferred embodiment, the operating section is the cutting mechanism 14. However, the operating section may be modified as required as long as the operating section produces effect on the target surface. The operating section may be, for example, a pen. In this case, the statement “the operating section produces effect on the target surface” means that the operating section abuts against the target surface, for example, the paper surface PS. Furthermore, as the operating section, for example, a punch may be employed. In this case, the statement “the operating section produces effect on the target surface” means that the operating section makes a through hole in the target surface (for example, the paper surface PS).

In the preferred embodiment, the blade 42, which functions as the operating section, is rotatable relative to the retaining section 29. However, the blade 42 may not rotate relative to the retaining section 29.

In the preferred embodiment, in the state where the actuating section 28 is not depressed, the coil spring 37 of the arranging mechanism 12 arranges the retaining section 29 such that the cutting mechanism 14 is apart from the paper surface PS. However, the retaining section 29 may be arranged such that the blade tip 42a abuts against the paper surface PS in the state where the actuating section 28 is not depressed. In this case, the actuating section 28 is configured such that the blade tip 42a is engaged in the sheet of paper P when the actuating section 28 is depressed.

Furthermore, the retaining section 29 may be configured such that the cutting mechanism 14 separates from the paper surface PS by depressing the actuating section 28. In this case, when the user stops depressing the actuating section 28, the blade tip 42a is engaged in the sheet of paper P.

The retaining section 29 may retain a detecting section for detecting the target surface instead of retaining the operating section. For example, when the retaining section 29 retains a sensor, which is the detecting section, the arranging mechanism 12 may arrange the retaining section 29 such that the sensor abuts against the paper surface PS. In this case, when depressing the actuating section 28, the sensor actuates. In this case, the position where the retaining section is arranged by the arranging section may be modified as required.

The retaining section 29 may retain a distance measuring section. The distance measuring section measures the distance between given points on the paper surface PS.

Furthermore, the actuating section 28 may be a sensor. When the actuating section 28 detects a hand, the retaining mechanism 13 may actuate and cause the blade tip 42a to be engaged in the sheet of paper P. That is, the configuration of the actuating section is not limited as long as the actuating section causes the operating section (the cutting mechanism 14) to produce effect on the target surface.

In the preferred embodiment, the retaining section 29 may be arranged in the arranging mechanism 12. In this case, a through hole is formed in the bottom plate 16 such that the blade 42 of the cutting mechanism 14 protrudes outside. As described above, in the state where the blade tip 42a is engaged in the sheet of paper P, the retaining section 29 may be located in the arranging mechanism 12. That is, the position of the retaining section 29 in the state where the blade tip 42a is engaged in the sheet of paper P may be changed as required.

The preferred embodiment may be modified such that the retaining section also functions as the actuating section. For example, the actuating section 28 is omitted. That is, the blade tip 42a is engaged in the sheet of paper P by directly depressing the retaining section 29.

In the preferred embodiment, the retaining section 29 may be omitted, and the cutting mechanism 14 may be attached to the connector 30. In this case, the connector 30 functions as the retaining section. In this case, the actuating section 28 may further be omitted. For example, the blade tip 42a may be engaged in the sheet of paper P by depressing the upper surface of the cutting mechanism 14. In this case, the operating section functions also as the actuating section.

In the preferred embodiment, the retaining section may also function as the arranging section. For example, a sensor is arranged in the arranging mechanism 12, and a through hole is formed in the bottom plate 16 at a position corresponding to the sensor. In this case, the sensor actuates by depressing the actuating section 28, and the sensor detects characters and figures on the target surface through the through hole.

In the preferred embodiment, the arranging section may also function as the operating section. For example, the actuating section 28 is omitted, and a ball-shaped rolling section is provided on the bottom plate 16. In this case, depressing the arranging mechanism 12 in a state where the rolling section abuts against the paper surface PS lowers the arranging mechanism 12 toward the paper surface PS causing the blade tip 42a to be engaged in the sheet of paper P.

In the preferred embodiment, in the state where the retaining section 29 retains the cutting mechanism 14 at a position apart from the paper surface PS, the rotary shaft 40 may be inclined with respect to the paper surface PS. In this case, in the state where the blade tip 42a is engaged in the sheet of paper P, the connector 30 flexes so that the rotary shaft 40 becomes perpendicular to the paper surface PS. The connector 30 is preferably made of a flexible material.

In the preferred embodiment, a side surface of the arranging mechanism 12 in the width direction may be flat. In this case, the side surface of the arranging mechanism 12 is abut against a ruler, and the arranging mechanism 12 is slid along the ruler. This allows the user to easily cut the sheet of paper P along a straight line. At least part of the side surfaces of the arranging mechanism 12 may be flat so that the ruler can be placed against the arranging mechanism 12.

The present examples and embodiments are to be considered as illustrative and not restrictive and the invention is not to be limited to the details given herein, but may be modified within the scope and equivalence of the appended claims.

1. An assisting apparatus for assisting an operating section, which produces effect on a target surface, the assisting apparatus comprising:
a retaining section for detachably retaining the operating section;
an arranging section placed on the target surface so as to arrange the retaining section on the target surface; and
an actuating section for actuating the operating section such that the operating section produces effect on the target surface in a state where the retaining section retains the operating section.

2. The assisting apparatus according to claim 1,
wherein, in a state where the operating section produces effect on the target surface, the operating section contacts the target surface,
wherein, when the actuating section is not actuated, the arranging section arranges the retaining section such that the operating section is apart from the target surface, and
wherein the retaining section approaches the target surface based on the actuation of the actuating section and contacts the target surface.

3. The assisting apparatus according to claim 2,
wherein the operating section has a contact portion, which contacts the target surface and is rotatable with respect to the retaining section, and
wherein, in a state where the operating section contacts the target surface, the retaining section makes the rotational axis of the contact portion to be perpendicular to the target surface.

4. The assisting apparatus according to claim 1,
wherein the actuating section is a push-button, the retaining section being movable relative to the arranging section, and the retaining section moves between an actuating position at which the operating section produces effect on the target surface and a stand-by position at which the operating section is apart from the target surface,
the assisting apparatus further comprising an urging section, the urging section urging the push-button toward the stand-by position, and
wherein, when the push-button is depressed, the retaining section is arranged at the actuating position against the force of the urging section.

5. The assisting apparatus according to claim 4,
wherein the arranging section is configured to be slidable along the target surface, and
wherein the push-button is configured to be depressed in a direction intersecting the target surface.

6. The assisting apparatus according to claim 4, further comprising:
a lock mechanism for locking the retaining section at the actuating position.

7. The assisting apparatus according to claim 6,
wherein the lock mechanism has a slidable lock lever, the lock lever being movable between a lock position at which the movement of the retaining section is restricted and an unlock position at which the restriction is cancelled.

8. The assisting apparatus according to claim 1,
wherein the operating section includes a blade for cutting the target surface and a blade holder for retaining the blade, the blade holder being transparent.

9. The assisting apparatus according to claim 1,
wherein the operating section includes a blade for cutting the target surface and a blade holder for retaining the blade, the blade holder having an abutment surface, which abuts against the target surface in a state where the blade produces effect on the target surface.

10. The assisting apparatus according to claim 1, further comprising:
a stopping section for restricting movement of at least one of the retaining section and the operating section in a state where the operating section contacts the target surface.

11. An assisting apparatus for actuating a detecting section, which detects a target surface, the assisting apparatus comprising:
a retaining section for detachably retaining the detecting section;
an arranging section placed on the target surface so as to arrange the retaining section on the target surface; and
an actuating section for actuating the detecting section such that the detecting section detects the target surface in a state where the retaining section retains the detecting section.

12. An actuating apparatus comprising:
an operating section for producing effect on a target surface;
a retaining section for retaining the operating section;
an arranging section placed on the target surface so as to arrange the operating section on the target surface by means of the retaining section; and
an actuating section for actuating the operating section to produce effect on the target surface.

13. The actuating apparatus according to claim 12,
wherein, in a state where the operating section produces effect on the target surface, the operating section contacts the target surface,
wherein, when the actuating section is not actuated, the arranging section arranges the retaining section such that the operating section is apart from the target surface, and
wherein the retaining section approaches the target surface based on the actuation of the actuating section and contacts the target surface.

14. The actuating apparatus according to claim 13,
wherein the operating section has a contact portion, which contacts the target surface and is rotatable with respect to the retaining section, and
wherein, in a state where the operating section contacts the target surface, the retaining section causes the rotational axis of the contact portion to be perpendicular to the target surface.

15. The actuating apparatus according to claim 12,
wherein the actuating section is a push-button, the retaining section being movable relative to the arranging section, and the retaining section moves between an actuating position at which the operating section produces effect on the target surface and a stand-by position at which the operating section is apart from the target surface,
wherein the assisting apparatus further includes an urging section, the urging section urging the push-button toward the stand-by position,
wherein, when the push-button is depressed, the retaining section is arranged at the actuating position against the force of the urging section,
wherein the arranging section is configured to be slidable along the target surface, and
wherein the push-button is configured to be depressed in a direction intersecting the target surface.
